(19) United States
(12) Patent Application Publication
(10) Pub. No.: US 2012/0101669 A1
(43) Pub. Date: Apr. 26, 2012

(54) Sail Usage Sensing System and Method

(76) Inventor: Grant Spanhake, Annapolis, MD (US)

(21) Appl. No.: 13/279,867

(22) Filed: Oct. 24, 2011

Related U.S. Application Data
(60) Provisional application No. 61/405,769, filed on Oct. 22, 2010.

(51) Int. Cl. G01M 17/00

(52) U.S. Cl. 701/21

(57) ABSTRACT

A system for collecting and analyzing sail usage data. The system has a sensor on a sail for sensing heel, vibration or tension on the sail, an RFID tag connected to the sensor, an RFID tag reader for reading data of the first parameter from the RFID tag, a memory for storing data read from the RFID tag and a processor for processing the data from the RFID tag. Data received from the sensor is processed to determine a number of hoists of the sail and an amount of time during which the sail was in a hoisted position. The data from the sensor is used to determine which tack the sailboat was on and how long it was on that tack.

### CROSS-REFERENCE TO RELATED APPLICATIONS

The present application claims the benefit of the filing date of U.S. Provisional Patent Application Ser. No. 61/405,769 filed by the present inventor on Oct. 22, 2010.

The aforementioned provisional patent application is hereby incorporated by reference in its entirety.

### STATEMENT REGARDING FEDERALLY SPONSORED RESEARCH OR DEVELOPMENT

None.

### BACKGROUND OF THE INVENTION

1. Field of the Invention

The present invention relates to generally to the application of sensors to sails and more specifically to the collection and analysis of sail usage data via sensors applied to sails.

2. Brief Description of the Related Art

Sensors have been used for a variety of applications. For example, in U.S. Patent Application Publication No. 2010/0280416 entitled “Shape Sensing Clothes to Inform the Wearer of a Condition,” a number of sensors and circuitry were placed in a garment to communicate information related to a physiological condition of a user. In U.S. Patent Application Publication No. 2011/0098576 entitled “Non-Invasive Implant Rupture Detection System” devices and methods were disclosed for using sensors for implant rupture detection. In U.S. Patent Application Publication No. 2010/0201378 entitled “Method and System for Remote Monitoring Deformations of a Structure,” a system and method for using a plurality of RFID tags to monitor the deformation of a structure is disclosed. In U.S. Pat. No. 7,992,217 entitled “Shape Changing Material,” an apparatus configured with one or more sensors for detecting shape related parameters is disclosed.

Additionally, various electronics systems have been used in connection with sailboats. In U.S. Pat. No. 4,671,201 entitled “Method and Apparatus of Automatically Controlling a Sailboat” there is disclosed a system of sensors for sensing wind direction to determine the angle of sail in each of the sails, tensions and/or vibrations in each of the sails to adjust the curvature of that sail, and wind velocity to take in the sails. In U.S. Pat. No. 6,308,649 entitled “Sailboat and Crew Performance Optimization System,” a system of sensors is used to monitor external factors (wind speed, wind direction, etc.), performance parameters (boat speed, time to reach specified destination, etc.), dependant variable set points (sail shape, sail pressure distribution, etc.) and control variables (line tensions, rudder angle, etc.). The collected data is used to evaluate the performance of the boat and its crew.

### SUMMARY OF THE INVENTION

In a preferred embodiment, the present invention is a system and method for collecting and transmitting sail usage data via RFID tags placed on or in the sails. The system for collecting and analyzing sail usage data has a sensor or sensors on a sail, an RFID tag connected to the sensor(s), an RFID tag reader for reading data from the RFID tag, a memory for storing data read from the RFID tag and a processor for processing said data from said RFID tag. The sensor can measure a variety of parameters such as load, vibration, heel, tension, etc. The processor and process or manipulate the various data received to analyze usage and performance.

In another preferred embodiment, the present invention is a system for collecting and analyzing sail usage data. The system comprises a sensor on a sail for sensing a first parameter associated with the sail, wherein the first parameter comprises one of vibration and heel, an RFID tag connected to the sensor, an RFID tag reader for reading data of the first parameter from the RFID tag, a memory for storing data read from the RFID tag and a processor for processing the data from the RFID tag. The data comprises date and time data together with corresponding data of the first parameter. The system may further comprise a second sensor on the sail connected to the same or a different RFID tag on the sail. The second sensor may sense a second parameter associated with the sail wherein the second parameter is different than the first parameter or may sense the first parameter associated with the sail at a different location on the sail the sensor for sensing the first parameter. The first parameter may comprise vibration and the processor may processes vibration data from the sensor to determine whether the sail is in a hoisted or unhoisted position. The first parameter may comprises vibration and the processor may process vibration data and time data received from the RFID tag to determine an amount of time in during which the sail is in a hoisted position. The first parameter may comprise heel and the processor processes heel data from the sensor to determine whether the sail is in a hoisted or unhoisted position. The first parameter may comprise heel and the processor processes heel data and time data received from the RFID tag to determine an amount of time in during which the sail is in a hoisted position. The first parameter comprises heel and the processor processes heel data from the sensor to determine which tack a sailboat bearing the sail is on. The first parameter may comprise heel and the processor may process heel data and time data received from the RFID tag to determine an amount of time during which a sailboat bearing the sail is on a particular tack.

In yet another embodiment, the present invention is a system for collecting and analyzing sail usage data. The system comprises a sensor on a sail for sensing a load data associated with the sail, an RFID tag connected to the sensor, an RFID tag reader for reading load data from the RFID tag, a memory for storing load data read from the RFID tag and a processor for processing the load data from the RFID tag to determine one of whether the sail is in a hoisted or unhoisted position and whether which tack a sailboat bearing the sail is on. The load data may comprises tension data and the processor processes the tension data to determine which tack a sail is on. The processor may generate sail usage analyses and output such analyses to a display.

Still other aspects, features, and advantages of the present invention are readily apparent from the following detailed description, simply by illustrating a preferable embodiments and implementations. The present invention is also capable of other and different embodiments and its several details can be modified in various obvious respects, all without departing from the spirit and scope of the present invention. Accordingly, the drawings and descriptions are to be regarded as illustrative in nature, and not as restrictive. Additional objects and advantages of the invention will be set forth in part in the description which follows and in part will be obvious from the description, or may be learned by practice of the invention.

### BRIEF DESCRIPTION OF THE DRAWINGS

For a more complete understanding of the present invention and the advantages thereof, reference is now made to the following description and the accompanying drawings, in which:

FIG. 1 is a diagram of sensors placed on or in various sails in accordance with various embodiments of the present invention.

FIG. 2 is a flow diagram of a method for collecting and analyzing sail usage data in accordance with a preferred embodiment of the present invention.

FIG. 3 is a block diagram of a sail usage sensing system in accordance with a preferred embodiment of the present invention.

FIG. 4 is a diagram of a spreadsheet illustrating data collected in accordance with a preferred embodiment of the present invention.

FIG. 5 is a diagram of a spreadsheet illustrating data collected in accordance with another preferred embodiment of the present invention.

FIG. 6 is a diagram of a spread sheet illustrating data collected in accordance with another preferred embodiment of the present invention.

FIG. 7 is a diagram of a course taken by a sailboat.

### DETAILED DESCRIPTION OF THE PREFERRED EMBODIMENTS

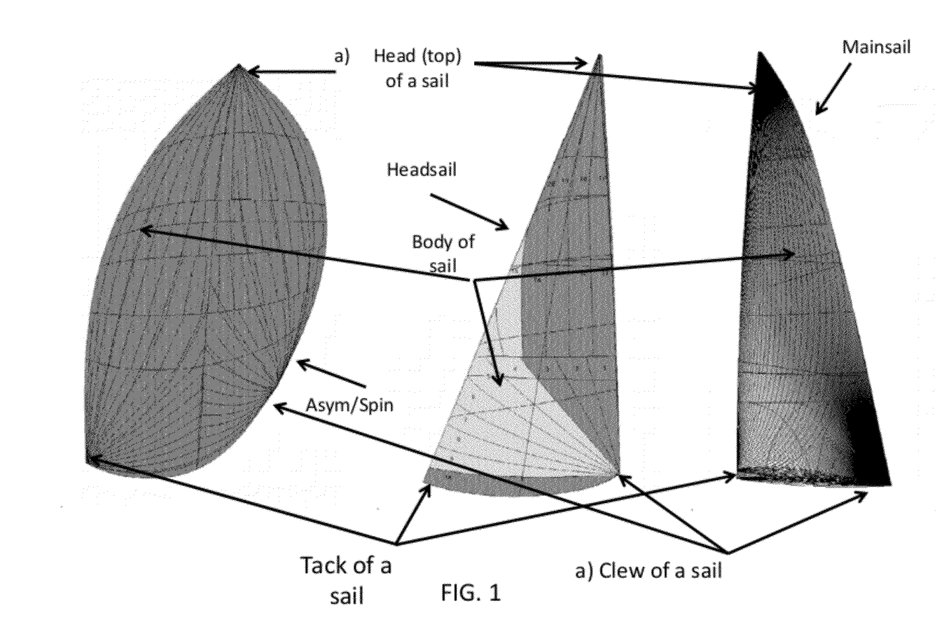

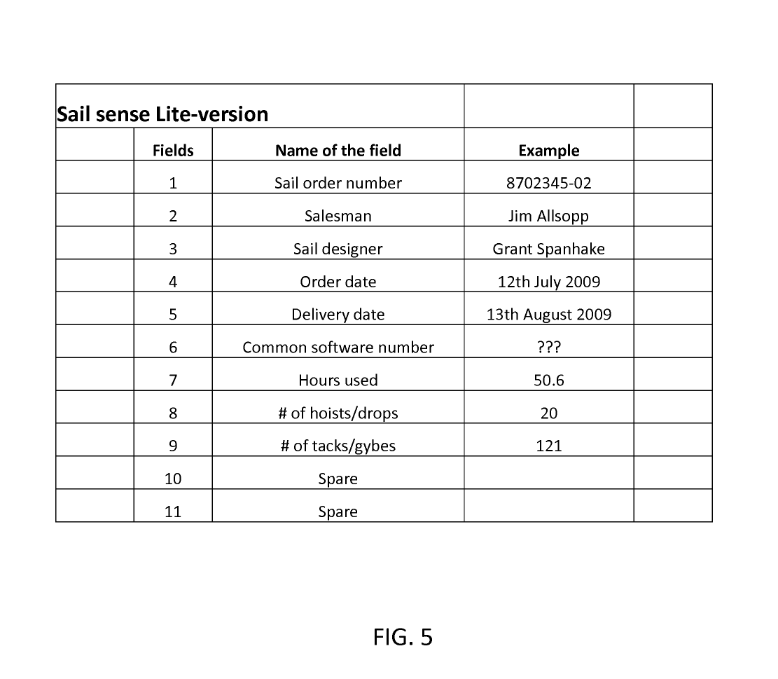

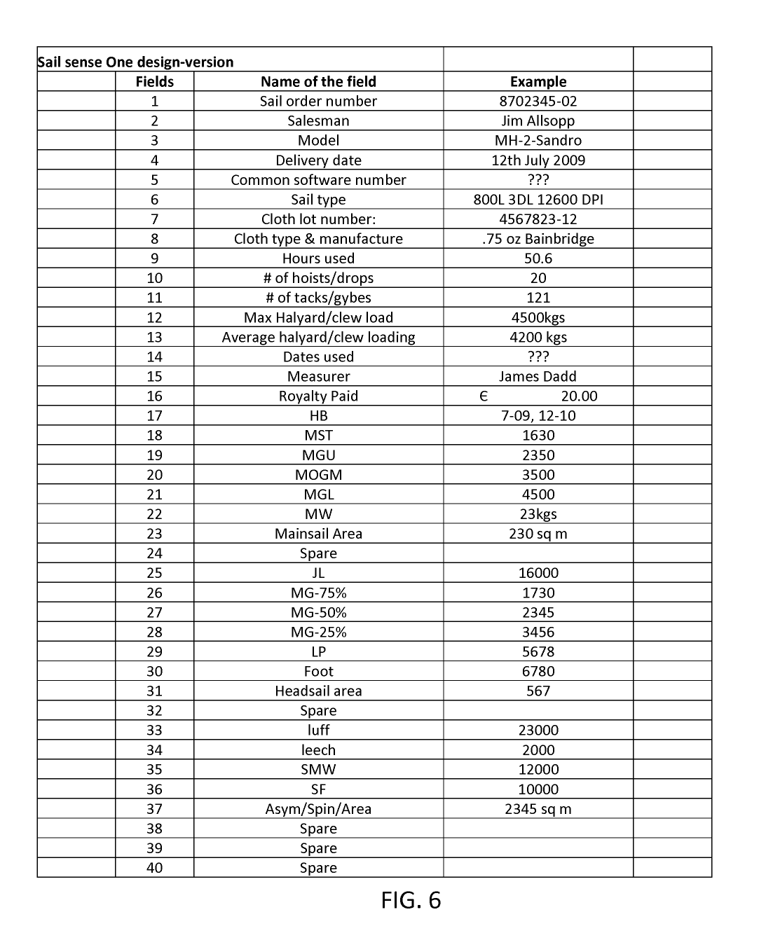

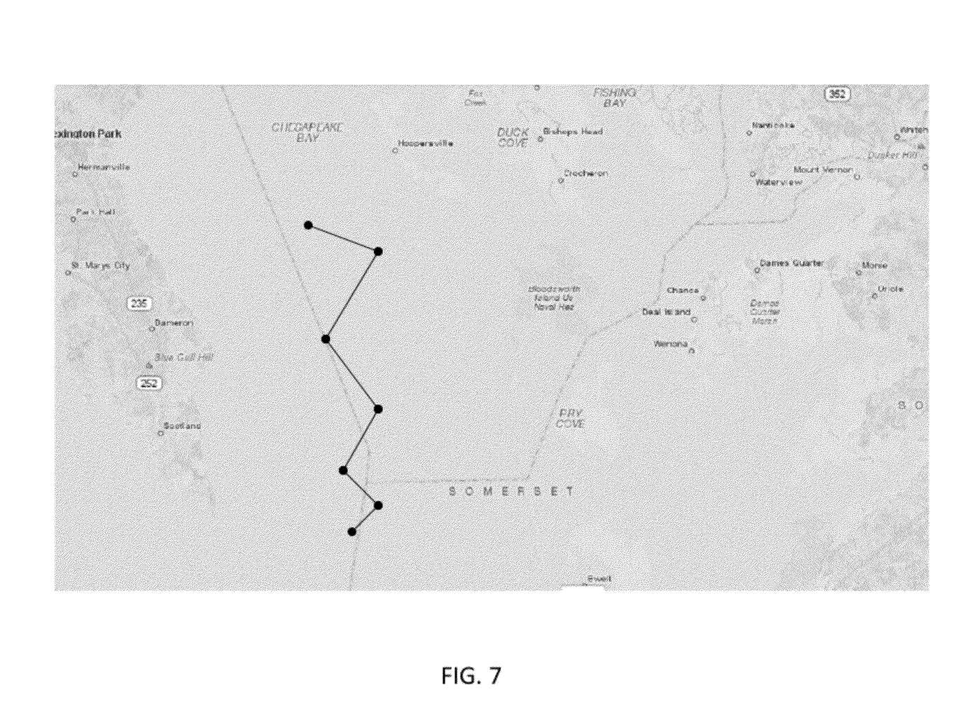

Preferred embodiments of the present invention will be described with reference to FIGS. 1-7. The present invention provides for the placement of sensors on sailboat sails to allow for monitoring, retrieval, storing, and analyzing of sail usage data such as hours of usage, number of hoists/drops, number of tacks or gybes, maximum halyard or clew load, average halyard or clew load, dates of use, heel, vibration and even weather conditions during use. RFID tags together with sensors, which may be integral with the RFID tags or electronically connected to the RFID tags, are placed on sails to record usage hours, corner loads, and various other information. As shown in FIG. 1, the RFID tag/sensor combination may be placed, for example, at the head or top corner of a sail, at the clew of a sail, at the tack of a sail, or some combination of multiple sensors in such locations.

By sensing various parameters, data may be collected and used to determine the number of hours of usage, number of hoists/drops, number of tacks or gybes, maximum halyard or clew load and average halyard or clew load. Such calculations, for example, may be made by a processor that receives load data after reading the tags. For example, vibration sensors may be used to determine a number of times a sail has been hoisted and the number of hours the sail has been in a hoisted position. A threshold level of vibration may be determined such that whenever a level of vibration is sensed above that threshold, the system determines that the sail is in a hoisted position. Additional safeguards, such as providing for the ability to turn the sensor, system, or reader off during non-sailing transport of a sail, may be provided. In another example, a reading of the heel of a hoisted sail is used to determine which tack a sailboat is on, possibly how strong the prevailing wind is at the time, and how long a sailboat is on a particular tack. In some embodiments, the global positioning system or GPS may be combined with the system to allow, for example, for reconstruction of a race in terms of location, heel, tack, etc.

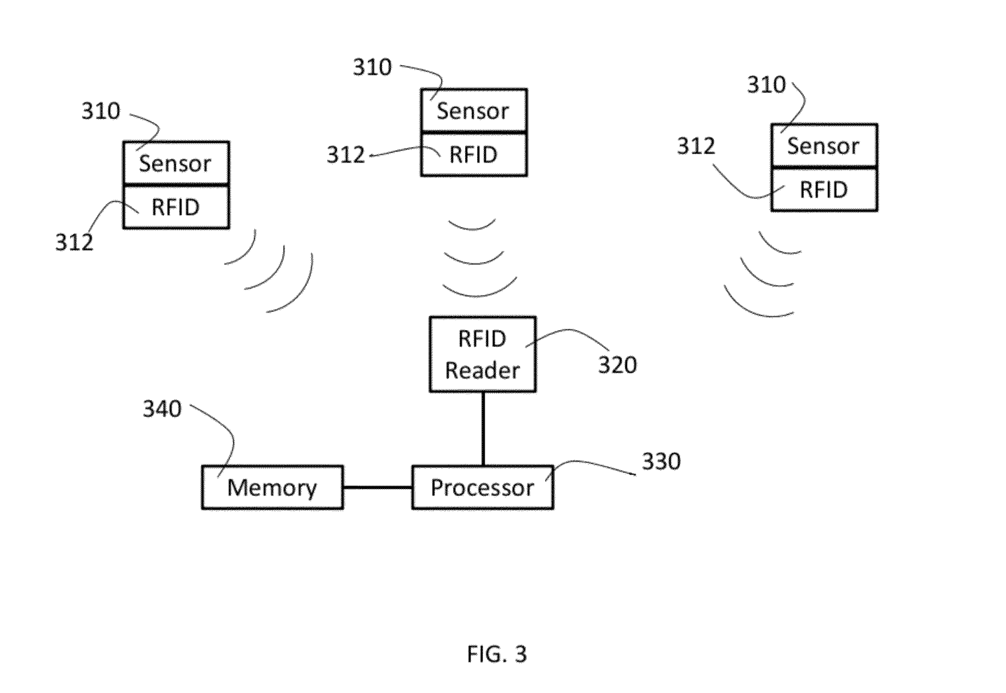

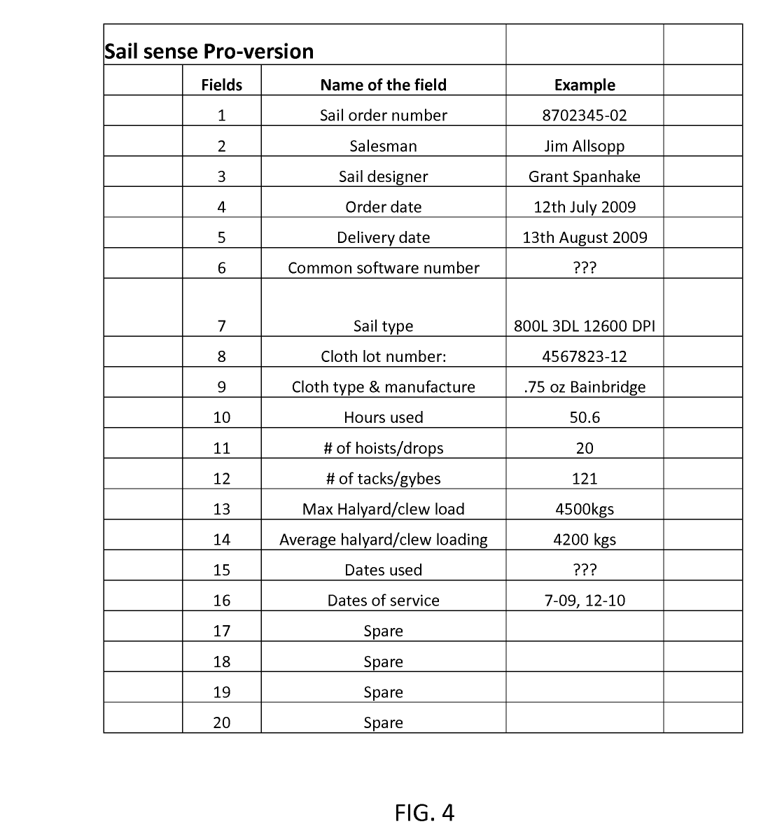

As shown in FIG. 3, the system has a sensor 310-RFID 312 combination in one or more locations on one or more sails on a sailboat. Preferably the RFID/sensors will have a power source such as a battery that will last at least 1-5 years. The RFIG tags may be placed in, on or around a corner patch reinforcing a sail. The RFID tags 312 are read by a reader 320, which may be an independent device or may be, for example, and RFID reader connected to a mobile phone such as an RFID reader for an iPhone, Blackberry, PDA, iPad, computer or other mobile device. In alternative embodiments, a reader or readers could be located in fixed locations, such as on a boat, pier or a sail manufacturer or maintenance facility. The RFID reader 320 is connected to a processor 330, which may be integral with the reader or may be physical separate but connected to the reader in wired or wireless fashion. The processor 330 has a memory 340 for storing sail usage data. The processor may process or analyze the data of present the data for human analysis, such as by formatting the data into a spreadsheet. Exemplary formats for such spreadsheets with examples of types of data that may be collected, stored or analyzed are shown FIGS. 4-6. As will be discussed below, a preferred embodiment also may include hardware and software that allows for writing to a tag to store various types of data on the tag itself.

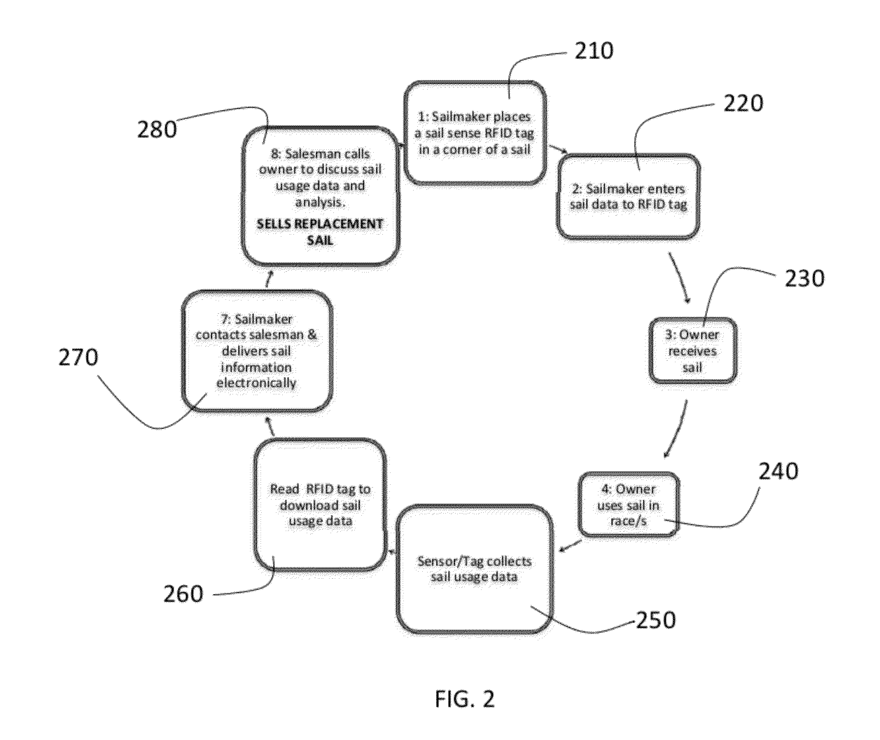

A flow chart illustrating and exemplary method of how the present invention may be used is shown in FIG. 2. At step 210, a sailmaker places an RFID/sensor in a corner of a sail. At step 220, the sailmaker enters preliminary sail data into the RFID tag (and/or may store such data locally at the sailmaker's facility). At step 230, the sailboat owner receives the sail. At step 240, the owner uses the sail, for example in races. During such races, the RFID/sensor records a variety of data regarding sail usage as discussed above. At steps 250 or 260, the RFID/sensor is read via an RFID reader to download the sail usage data from the tag. For example, the RFID/sensor may be read by the owner into a mobile phone which then transmits the data to the sailmaker or the data may be read when the sail is maintained at a log. Similarly, the RFID/sensor could be interrogated whenever the sailboat and sail or located at a pier or marina having the RFID readers. At step 270, the sailmaker provides usages analysis data to a salesman or to the owner, for example electronically or in print. At step 280, the salesman contacts the owner to discuss usage data and perhaps make recommendations.

Alternatively, the “human” aspects of such method could be replaced with automatic electronic methods in which data collected electronically is read or transmitted electronically in an automatic fashion at particular intervals or when the sail with tags is at particular locations. Similarly, the data reading/analysis could be initiated by input from a user of the sail. The data may be processed and analyzed and recommendation for sail maintenance or replacement could be made via predictive algorithms and presented to a user via a display or printout.

In other embodiments, a device and method in accordance with the present invention provide for reconstruction and analysis of a sailboat race. The sensors placed in the sails record usage data such as vibration and heel. The RFID tag transmits such data to the RFID reader. The data is stored in memory or storage. Later, the processor retrieves the data and analyzes the data to determine, for example, the time spent on each tack and the heel while on each tack. This data may be combined with other data such as GPS data or weather data to provide feedback to sailors on their performance. The data may be shown in a display, for example, in table form or graphical form or may be printed in hard copy on a printing means. Data could be sent, for example, to a mobile phone or other device and displayed on such device. Data from multiple races or training sessions can be displayed and compared.

The foregoing description of the preferred embodiment of the invention has been presented for purposes of illustration and description. It is not intended to be exhaustive or to limit the invention to the precise form disclosed, and modifications and variations are possible in light of the above teachings or may be acquired from practice of the invention. The embodiment was chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A system for collecting and analyzing sail usage data comprising:
a sensor on a sail for sensing a first parameter associated with said sail, wherein said first parameter comprises one of vibration and heel;
an RFID tag connected to said sensor;
an RFID tag reader for reading data of said first parameter from said RFID tag;
a memory for storing data read from said RFID tag; and
a processor for processing said data from said RFID tag.

2. A system according to claim 1 wherein said data comprises date and time data together with corresponding data of said first parameter.

3. A system according to claim 1 further comprising a second sensor on said sail connected to an RFID tag on said sail.

4. A system according to claim 3 wherein said second sensor senses a second parameter associated with said sail wherein said second parameter is different than said first parameter.

5. A system according to claim 3 wherein said second sensor senses a said first parameter associated with said sail at a different location on said sail said sensor for sensing said first parameter.

6. A system according to claim 1 wherein said first parameter comprises vibration and said processor processes vibration data from said sensor to determine whether said sail is in a hoisted or unhoisted position.

7. A system according to claim 2 wherein said first parameter comprises vibration and said processor processes vibration data and time data received from said RFID tag to determine an amount of time in during which said sail is in a hoisted position.

8. A system according to claim 1 wherein said first parameter comprises heel and said processor processes heel data from said sensor to determine whether said sail is in a hoisted or unhoisted position.

9. A system according to claim 2 wherein said first parameter comprises heel and said processor processes heel data and time data received from said RFID tag to determine an amount of time in during which said sail is in a hoisted position.

10. A system according to claim 1 wherein said first parameter comprises heel and said processor processes heel data from said sensor to determine which tack a sailboat bearing said sail is on.

11. A system according to claim 2 wherein said first parameter comprises heel and said processor processes heel data and time data received from said RFID tag to determine an amount of time during which a sailboat bearing said sail is on a particular tack.

12. A system for collecting and analyzing sail usage data comprising:
a sensor on a sail for sensing a load data associated with said sail;
an RFID tag connected to said sensor;
an RFID tag reader for reading load data from said RFID tag;
a memory for storing load data read from said RFID tag; and
a processor for processing said load data from said RFID tag to determine one of whether said sail is in a hoisted or unhoisted position and whether which tack a sailboat bearing said sail is on.

13. A system according to claim 12 wherein said load data comprises one of vibration data, tension data and heel data.

14. A system according to claim 12 wherein said load data comprises vibration data and said processor processes said vibration data to determine whether said sail is in a hoisted or unhoisted position.

15. A system according to claim 12 wherein said load data comprises tension data and said processor processes said tension data to determine which tack a sail is on.

16. A system according to claim 12 further comprising a display for displaying sail usage analyses generated by said processor.
